(19) United States
(12) Patent Application Publication
(10) Pub. No.: US 2007/0071078 A1
(43) Pub. Date: Mar. 29, 2007

(54) Radio apparatus

(76) Inventors: Hiroshi Yoshida, Yokohama-shi (JP); Yasuhiko Tanabe, Kawasaki-shi (JP); Hidenori Okuni, Kawasaki-shi (JP); Hiroki Shoki, Kawasaki-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/389,214

(22) Filed: Mar. 27, 2006

(30) Foreign Application Priority Data
Sep. 29, 2005 (JP) 2005-283631

(51) Int. Cl. H04L 5/16

(52) U.S. Cl. 375/219

(57) ABSTRACT

A radio apparatus includes a first radio-frequency unit configured to receive a reception signal transmitted from a communication partner, and configured to transmit a transmission signal to the communication partner, a second radio-frequency unit configured to receive a reception signal transmitted from the communication partner, configured to transmit a transmission signal to the communication partner, a baseband processing unit configured to be supplied with the reception signal from each of the first and second radio-frequency units, and supply, to each of the first and second radio-frequency units, data to be transmitted to the communication partner, and the baseband processing unit configured to generate a reference signal supplied to each of the first radio-frequency unit and the second radio-frequency unit, and a digital signal supplying unit configured to supply a digital signal containing the reference signal from the baseband processing unit to each of the first and second units.

### CROSS-REFERENCE TO RELATED APPLICATIONS

This application is based upon and claims the benefit of priority from prior Japanese Patent Application No. 2005-283631, filed Sep. 29, 2005, the entire contents of which are incorporated herein by reference.

### BACKGROUND OF THE INVENTION

1. Field of the Invention

The present invention relates to a radio apparatus having a digital interface and, more particularly, to a radio apparatus having a plurality of radio units.

2. Description of the Related Art

Conventionally, in a radio apparatus including an RF (Radio Frequency) unit (radio unit) and a baseband processing unit, an interface includes an analog signal line and a digital and/or analog control line. However, recently, along with the spread of CMOS (Complementary Metal-Oxide Semiconductor) RF-ICs (Integrated Circuit), an ADC (Analog/Digital Converter) or DAC (Digital/Analog Converter) can be incorporated in the RF-IC. Under-this situation, so-called DigRF for connecting the RF-IC to a digital IC via a digital interface is standardized (see, e.g., [searched on Aug. 4, 2005] in the Internet <URL: http://146.101.169.51/DigRF %20Standard %20v112.pdf> “DigRF BASEBAND/RF DIGITAL INTERFACE SPECIFICATION Logical, Electrical and Timing Characteristics EGPRS Version, Digital Interface Working Group, Rapporteur: Andrew Fogg, TTPCom, Version 1.12”, see the drawing on p. 6).

On the other hand, recently, a scheme called MIMO (Multi-Input, Multi-Output) which uses a plurality of radio units and antennas to increase the transmission speed has been researched and developed, and put into practical use. In such radio apparatus, signals must be transmitted and received, or controlled for the respective RF units.

However, since DigRF is originally a standard for GSM (Global System for Mobile communications), it is not premised on an arrangement having a plurality of RF units, such as MIMO which is examined to be applied to a next-generation wireless LAN and next-generation cellular phone. More specifically, in the MIMO-compatible radio apparatus, quartz oscillators for generating reference signals must be arranged in the respective RF units. However, since the characteristics of the respective oscillators vary, the characteristics of the signals to be demodulated and modulated by the radio units also vary, thus increasing an error rate.

### BRIEF SUMMARY OF THE INVENTION

In accordance with a first aspect of the invention, there is provided a radio apparatus comprising: a first radio-frequency unit configured to receive a reception signal transmitted from a communication partner, and configured to transmit a transmission signal to the communication partner; a second radio-frequency unit configured to receive a reception signal transmitted from the communication partner, configured to transmit a transmission signal to the communication partner; a baseband processing unit configured to be supplied with the reception signal from each of the first radio-frequency unit and the second radio-frequency unit, and supply, to each of the first radio-frequency unit and the second radio-frequency unit, data to be transmitted to the communication partner, and the baseband processing unit configured to generate a reference signal supplied to each of the first radio-frequency unit and the second radio-frequency unit; and a digital signal supplying unit configured to supply a digital signal containing the reference signal from the baseband processing unit to each of the first radio-frequency unit and the second radio-frequency unit.

In accordance with a second aspect of the invention, there is provided a radio apparatus comprising: a first radio-frequency unit configured to receive a reception signal transmitted from a communication partner, and configured to transmit a transmission signal to the communication partner; a second radio-frequency unit configured to receive a reception signal transmitted from the a communication partner, configured to transmit a transmission signal to the communication partner; a baseband processing unit configured to be supplied with the reception signal, and supply, to each of the first radio-frequency unit and the second radio-frequency unit, data to be transmitted to the communication partner, and the baseband processing unit configured to generate at least one of a switching control signal for switching a transmission operation and a reception operation in each of the first radio-frequency unit and the second radio-frequency unit, a power consumption control signal for changing power consumed by each of the first radio-frequency unit and the second radio-frequency unit, a transmission power control signal for changing transmission power in each of the first radio-frequency unit and the second radio-frequency unit, and a setting control signal for setting an oscillation frequency of each of the first radio-frequency unit and the second radio-frequency unit; and a digital signal supplying unit configured to transmit a digital signal containing the control signal from the baseband processing unit to each of the first radio-frequency unit and the second radio-frequency unit.

In accordance with a third aspect of the invention, there is provided a radio apparatus comprising: a first radio-frequency unit configured to receive a reception signal transmitted from a communication partner; a second radio-frequency unit configured to receive a reception signal transmitted from the communication partner; a baseband processing unit configured to be supplied with the reception signal, and supply, to each of the first radio-frequency unit and the second radio-frequency unit, data to be transmitted to the communication partner, and configured to supply power to the baseband processing unit and each of the first radio-frequency unit and the second radio-frequency unit; and a transmitting unit configured to transmit, from the baseband processing unit to each of the first radio-frequency unit and the second radio-frequency unit, power to be supplied to each of the first radio-frequency unit and the second radio-frequency unit.

In accordance with a fourth aspect of the invention, there is provided a radio apparatus comprising: a first radio-frequency unit configured to receive a reception signal transmitted from a communication partner; a second radio-frequency unit configured to receive a reception signal transmitted from the communication partner; a baseband processing unit configured to be supplied with the reception signal, and supply, to each of the first radio-frequency unit and the second radio-frequency unit, data to be transmitted to the communication partner, and configured to supply, to each of the first radio-frequency unit and the second radio-frequency unit, a power supply voltage output from an external battery; and a supplying unit configured to supply the power supply voltage from the baseband processing unit to each of the first radio-frequency unit and the second radio-frequency unit.

In accordance with a fifth aspect of the invention, there is provided a radio apparatus comprising: a first radio-frequency unit configured to receive a reception signal transmitted from a communication partner, and a transmission signal transmitter which transmits a transmission signal to the communication partner; a second radio-frequency unit configured to receive a reception signal transmitted from the communication partner, and a transmission signal transmitter which transmits a transmission signal to the communication partner; a baseband processing unit configured to be supplied with the reception signal, and supply, to each of the first radio-frequency unit and the second radio-frequency unit, data to be transmitted to the communication partner, and configured to generate an oscillation frequency signal for setting a transmission frequency or a reception frequency in each of the first radio-frequency unit and the second radio-frequency unit; and a supplying unit configured to supply the oscillation frequency signal from the baseband processing unit to each of the first radio-frequency unit and the second radio-frequency unit.

### BRIEF DESCRIPTION OF THE SEVERAL VIEWS OF THE DRAWING

FIG. 1 is a block diagram of a radio apparatus according to the first embodiment of the present invention;

FIG. 2 is a block diagram of a radio apparatus according to the second embodiment of the present invention;

FIG. 3 is a timing chart showing a CLOCK signal, DATA signal, and STROBE signal which are transmitted via a digital interface shown in FIG. 2;

FIG. 4 is a block diagram of a radio apparatus according to the modification of the second embodiment of the present invention;

FIG. 5 is a block diagram of a radio apparatus according to the third embodiment of the present invention;

FIG. 6 is a view showing a transmission period of a control signal in the radio apparatus shown in FIG. 5;

FIG. 7 is a block diagram of a radio apparatus according to the modification of the third embodiment of the present invention;

FIG. 8 is a block diagram of a radio apparatus according to the fourth embodiment of the present invention;

FIG. 9 is a block diagram showing a detailed power feeding scheme in the radio apparatus shown in FIG. 8; and

FIG. 10 is a block diagram of a radio apparatus according to the fifth embodiment of the present invention.

### DETAILED DESCRIPTION OF THE INVENTION

A radio apparatus according to each embodiment of the present invention will be described below with reference to the accompanying drawing.

The radio apparatus according to the embodiment of the present invention can prevent degradation of its characteristics, with a simpler arrangement.

### First Embodiment

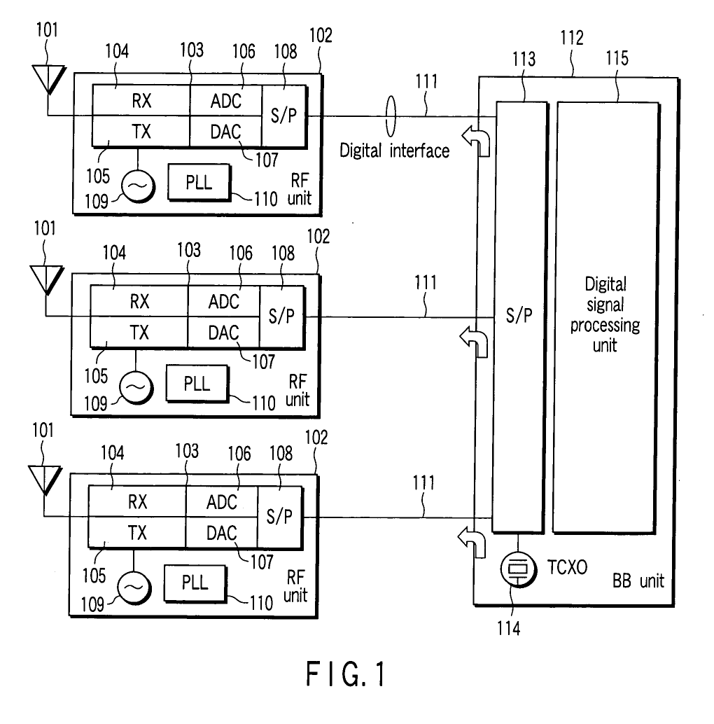

A radio apparatus according to the first embodiment of the present invention will be described with reference to FIG. 1. FIG. 1 is a block diagram when a baseband processing unit has a reference signal source, and a reference signal from the reference signal source is distributed to radio units via digital interfaces.

A plurality of antennas 101, RF units 102, and digital interfaces 111, and a baseband processing unit 112 are provided. Each RF unit 102 includes a radio unit 103, synthesizer (VCO: Voltage-Controlled Oscillator) 109, and PLL circuit 110. The radio unit 103 serves as an RF-IC, and incorporates a receiver (RX) 104, a transmitter (TX) 105, a reception ADC 106, a transmission DAC 107, and a serial-to-parallel converter (S/P) 108. The baseband processing unit 112 serves as a baseband IC, and incorporates a serial-to-parallel converter 113, a temperature compensation quartz oscillator (TCXO) 114 serving as the reference signal source, and a digital signal processing unit 115. Note that in each of the following embodiments, a MIMO radio apparatus having three RF units 102 is exemplified. In this arrangement, the receiver 104 receives a plurality of different signals transmitted from a communication partner at the same frequency. The baseband processing unit 112 demultiplexes the signal received by each receiver, and multiplexes the demultiplexed signals, thereby reconstructing one piece of information. On the other hand, each transmitter 105 transmits different signals at the same frequency via the antenna 101. The synthesizer 109 is an oscillator which oscillates at a predetermined oscillation frequency. The oscillation frequency changes depending on an applied voltage.

The TCXO 114 generates a reference signal corresponding to a reference frequency used in the PLL circuit 110.

The PLL circuit 110 generally includes a phase detector (not shown), loop filter (not shown), and frequency divider (not shown). The PLL circuit 110 compares the oscillation frequency of the synthesizer 109 with the frequency of a reference frequency generator (TCXO 114 in the first embodiment). The PLL circuit 110 then controls to pass the output from the phase detector through the loop filter, feed back the output to the synthesizer 109, and accurately match the phases of the reference frequency and the output.

The serial-to-parallel converter 108 in each radio unit 103 is connected to the serial-to-parallel converter 113 in each baseband processing unit 112 via each digital interface 111.

As the characteristic feature of the first embodiment, the reference signal generated by the TCXO 114 is transmitted to each RF unit 102 via the digital interface 111. More specifically, this feature is effective for the radio apparatus including the plurality of RF units 102 as shown in FIG. 1.

The reference signal transmitted from the TCXO 114 via the digital interface 111 is used as a PLL reference signal for the synthesizers 109 incorporated in the respective RF units 102. In this arrangement, all the synthesizers 109 can share a common reference signal, and the oscillation frequencies of the synthesizers 109 can match each other.

Since the remaining components are generally used, a detailed description will be omitted, and the operations of the remaining components will be briefly described.

(Reception) The antenna 101 receives a signal, the receiver 104 receives this signal, and the ADC 106 converts the received signal into a digital signal. The serial-to-parallel converter 108 converts this digital signal into a serial signal, and this serial signal is transmitted to the serial-to-parallel converter 113 in the baseband processing unit 112 via the digital interface 111. The serial-to-parallel converter 113 reconverts this serial signal into the digital signal, and the digital signal processing unit 115 demodulates this digital signal.

(Transmission) The digital signal processing unit 115 generates a transmission signal, and the serial-to-parallel converter 113 converts this transmission signal into a serial signal. This serial signal is transmitted to the serial-to-parallel converter 108 in the RF unit 102 via the digital interface 111. The serial-to-parallel converter 108 converts this serial signal into a digital signal, and the DAC 107 converts this digital signal into an analog signal. The transmitter 105 transmits this analog signal as a transmission signal from the antenna 101.

As described above, in the radio apparatus according to the first embodiment, all the synthesizers 109 can share the common reference signal generated by the TCXO 114, and the oscillation frequencies of the synthesizers 109 can match each other. In this arrangement, the quartz oscillator need not be arranged in each RF unit, and the structure of the RF unit becomes simple to prevent the characteristics of the radio apparatus from degrading. The embodiment of the present invention is applied to the MIMO radio apparatus in which each receiver receives the plurality of different signals at the same frequency, thereby implementing the radio apparatus having higher performance.

### Second Embodiment

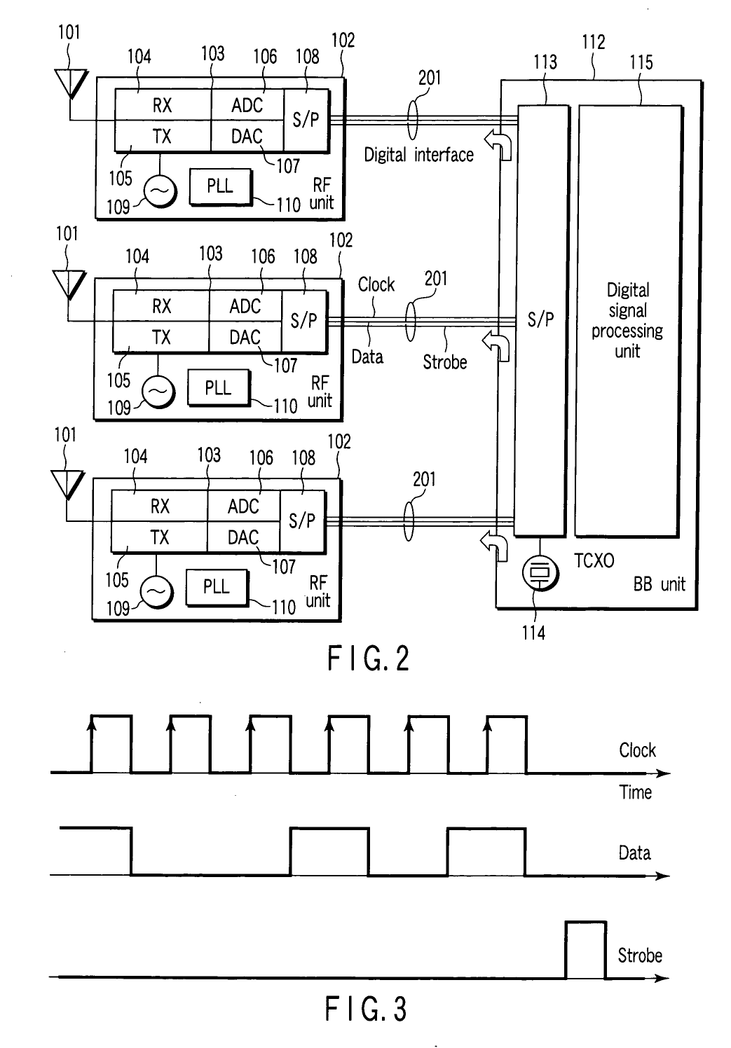

A radio apparatus according to the second embodiment of the present invention will be described with reference to FIGS. 2 and 3. As the characteristic feature of the second embodiment, a reference signal generated by a TCXO 114 in the first embodiment is transmitted as a clock of a digital interface 201. FIG. 2 is a block diagram when the signal from the TCXO is used as the reference clock of the digital interface, and the reference signal is clock-extracted from the transmitted serial bus signal on a radio unit side as the reference of a synthesizer. The same reference numerals described above denote the same components as those in the second embodiment, and a description thereof will be omitted.

In the second embodiment, the operation clock of the digital interface 201 serves as the reference signal of the TCXO 114. More specifically, as shown in FIG. 3, the reference signal of the TCXO 114 is used as CLOCK when serial transmission is performed via three interfaces, i.e., CLOCK, DATA, and STROBE interfaces.

In this arrangement, since CLOCK of the serial transmission data is used as a PLL reference signal in a radio unit 103, local oscillation outputs of the respective RF units 102 can match each other.

### Modification of Second Embodiment

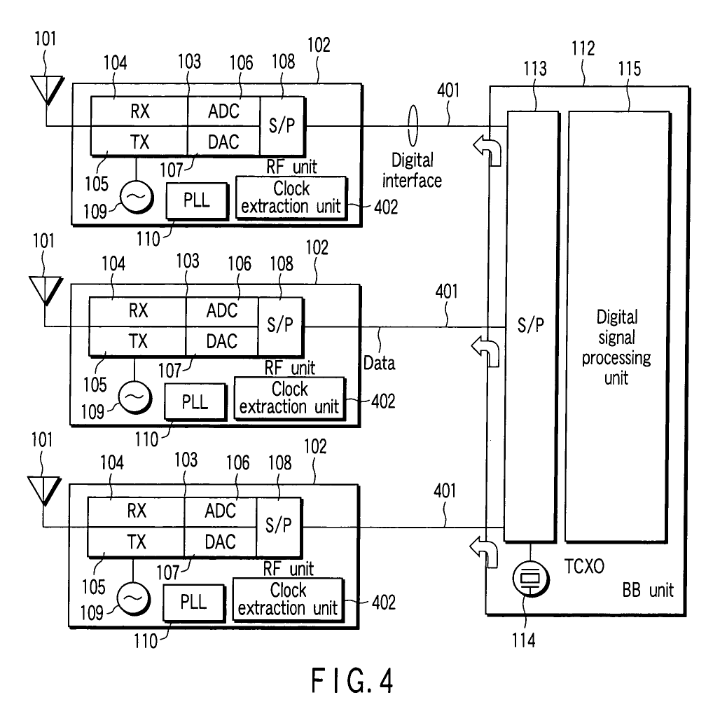

A modification of the second embodiment will be described with reference to FIG. 4. Similar to FIG. 2, FIG. 4 is a block diagram when the signal from the TCXO is used as the reference clock of the digital interface, and the reference signal is clock-extracted from the transmitted serial bus signal on a radio unit side as the reference of a synthesizer.

In this modification, each radio unit 103 additionally includes a clock extraction unit 402. Each RF unit 102 is connected to a baseband processing unit 112 via a digital interface 401 using one signal line.

Only a DATA signal is transmitted via the digital interface 401 serving as one serial signal line.

The clock extraction unit 402 receives the DATA signal, and clock extraction is done from this DATA signal. Since the clock-extracted signal is the same as the reference signal of the TCXO 114, this signal can be used as the reference signal for the synthesizers. As a result, similar to the above embodiments, local oscillation outputs of the respective radio units 103 can match each other.

In the description of the second embodiment, the operation clock of a digital interface 201 is completely the same as the reference signal from the TCXO 114. However, the clock signal and the reference signal may have the same phase. That is, for example, the same effect can be obtained even when an integral multiple (using a frequency multiplier) or integral fraction (using a frequency divider) of the frequency of the reference signal from the TCXO 114 serves as the operation clock of the digital interface 201 or 401.

As described above, in the second embodiment, all the synthesizers 109 can also share a common reference signal generated by the TCXO 114, and the oscillation frequencies of the synthesizers 109 can match each other. In this arrangement, a quartz oscillator need not be arranged in each RF unit, and the structure of the RF unit becomes simple to prevent the characteristics of the radio apparatus from degrading. Additionally, since a common signal from TCXO is used as the reference signal of the digital interface, the structure becomes very simple.

### Third Embodiment

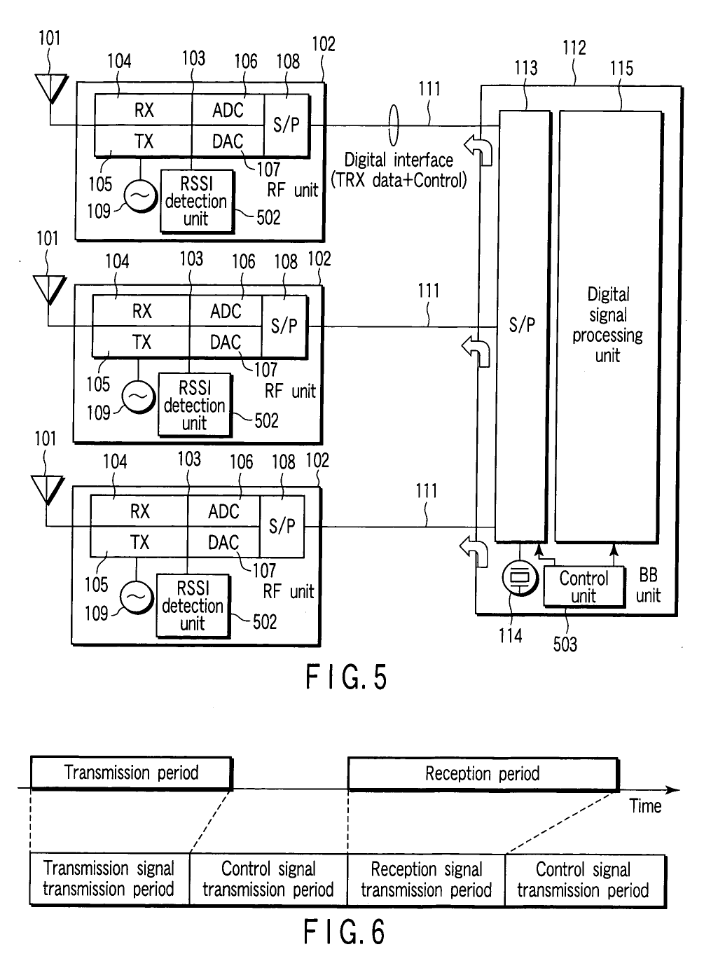

A radio apparatus according to the third embodiment of the present invention will be described with reference to FIGS. 5 and 6. FIG. 5 is a block diagram when a radio unit control signal is transmitted via a digital interface, this control signal includes at least a battery saving signal, transmission/reception switching signal, transmission power control signal, and synthesizer frequency setting signal from a baseband processing unit, and an RSSI signal is transmitted from the radio unit. In the third embodiment, control signals for controlling an RF unit 102 and baseband processing unit 112 are transmitted via a digital interface 111 described in the first embodiment. In the radio apparatus in the third embodiment, each RF unit 102 includes a radio unit 103, synthesizer (VCO: Voltage-Controlled Oscillator) 109, and PLL circuit 110, similar to that in the above-described embodiments. Additionally, in the third embodiment, the radio apparatus includes an RSSI detection unit 502 and control unit 503. The synthesizer 109 receives the control signal (a synthesizer frequency setting signal to be described later) from the control unit 503, and oscillates at a frequency designated in accordance with this control signal.

The RSSI detection unit 502 detects the strength information of the signal received by each RF unit 102, and outputs this strength information as an RSSI (Received Signal Strength Indicator) signal.

The control unit 503 generates various control signals, e.g., a battery saving signal, transmission/reception switching signal, transmission power control signal, and synthesizer frequency setting signal, and outputs the generated control signals to a digital signal processing unit 115 or serial-to-parallel converter 113. These control signals are then output to each RF unit 102 via the digital interface 111.

Examples of the control signals transmitted from the baseband processing unit 112 to the RF unit 102 are as follows.

(1) Battery saving signal: This signal is a signal for shifting the power supply of each RF unit 102 to a battery saving mode during, e.g., a standby period in order to reduce power consumption. If circumstances require, only some of the plurality of RF units 102 may be activated, and the remaining RF units may be shifted to the battery saving mode. Generally, this signal is a variable signal capable of changing the power consumption of the radio apparatus.

(2) Transmission/reception switching signal: In a packet communication system such as a wireless LAN, transmission and reception are not simultaneously carried out. In this case, a switching signal for switching between transmission and reception is transmitted to each RF unit 102.

(3) Transmission power control signal: The baseband processing unit 112 determines to change transmission power in accordance with a base station (access point) and propagation environment, and this control is implemented by the digital signal processing unit 115.

(4) Synthesizer frequency setting signal: This signal serves as an oscillation frequency setting signal for determining the oscillation frequency of a synthesizer in each RF unit 102, and is distributed from the baseband processing unit 112 to each of the RF units 102. In MIMO, the synthesizers in the respective RF units 102 use the same oscillation frequency. In the radio apparatus such as multichannel radio apparatus which performs transmission and reception by using a plurality of carrier frequencies, the oscillation frequencies of the synthesizers in the respective RF units 102 are set to different values.

Examples of the control signals transmitted from the RF unit 102 to the baseband processing unit 112 are as follows.

(1) RSSI signal indicating the strength of the received signal: The signal indicates a numerical value representing the strength of the signal received by each RF unit 102. For example, in MIMO, based on these numerical values, the baseband processing unit 112 performs calculation for demultiplexing the signal received by each receiver, as a MIMO reception process.

Conventionally, in the radio apparatus having the digital interface, the control signal is transmitted via a physically different signal line. Hence, the number of lines between the radio unit and the baseband processing unit increases, thus posing a problem especially in the radio apparatus having the plurality of radio units. However, in the third embodiment, since one digital interface 111 has the transmission functions of signal and control lines, the corresponding signals can be transmitted and received via the digital interface 111, thus reducing the number of lines as a great merit. Especially, in the radio apparatus according to the third embodiment, the baseband processing unit 112 and the RF unit 102 are simply connected to each other when these units are arranged at physically separate locations. Hence, this is very advantageous in terms of space and cost.

For example, as a scheme for superposing the control signal, the following schemes are available. One is a scheme for inserting the control signal between transmission and reception signals passing through the digital interface 111, and another is a scheme for arranging buffers in the serial-to-parallel converter 108 and serial-to-parallel converter 113, holding the signal in the buffer, transmitting the digital signal at a rate higher than a signal sampling rate, and inserting the control signal during an interval between the transmission processes. That is, as shown in FIG. 6, a control signal transmission period is set between transmission and reception periods.

### Modification of Third Embodiment

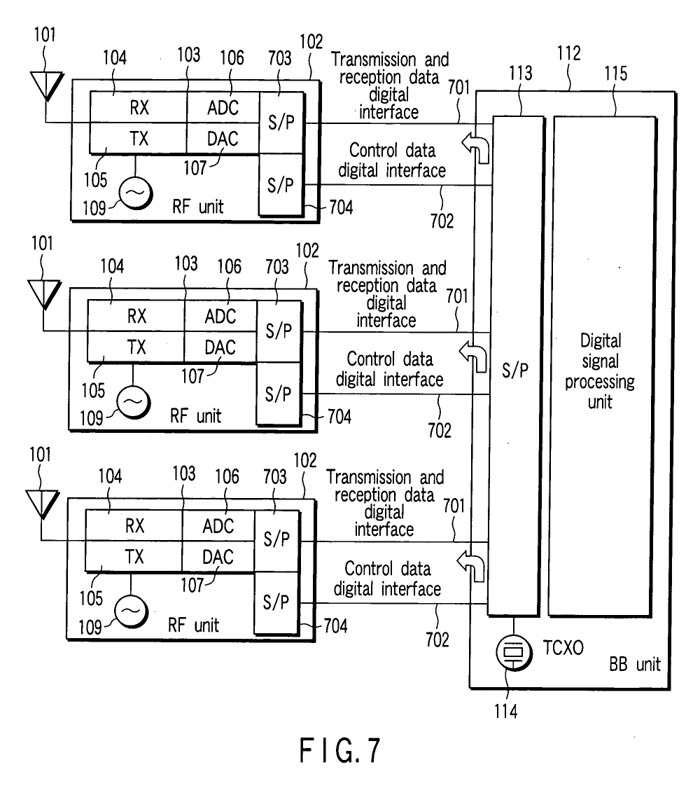

In this modification, control signals are collected and exchanged via a physically different signal line. A radio apparatus according to this modification will be described with reference to FIG. 7.

In this modification, each RF unit 102 includes two serial-to-parallel converters 703 and 704 which are connected to a serial-to-parallel converter 113 via respective digital interfaces 701 and 702. Transmission and reception data are transmitted between the serial-to-parallel converter 703 and the serial-to-parallel converter 113 via the digital interface 701, and control data is transmitted between the serial-to-parallel converter 704 and the serial-to-parallel converter 113 via the digital interface 702. Note that the example in the third embodiment may be combined with the modification of the third embodiment.

More specifically, in the radio apparatus such as MIMO having the plurality of RF units, since the RF units 102 are controlled centered on the baseband processing unit 112, the radio apparatus becomes very effective.

In the third embodiment, all synthesizers 109 can share a common reference signal generated by a TCXO 114, and the oscillation frequencies of the synthesizers 109 can match each other. In this arrangement, a quartz oscillator need not be arranged in each RF unit. Accordingly, the structure of the RF unit becomes simple to prevent degradation of the characteristics of the radio apparatus, e.g., an increase in error rate.

### Fourth Embodiment

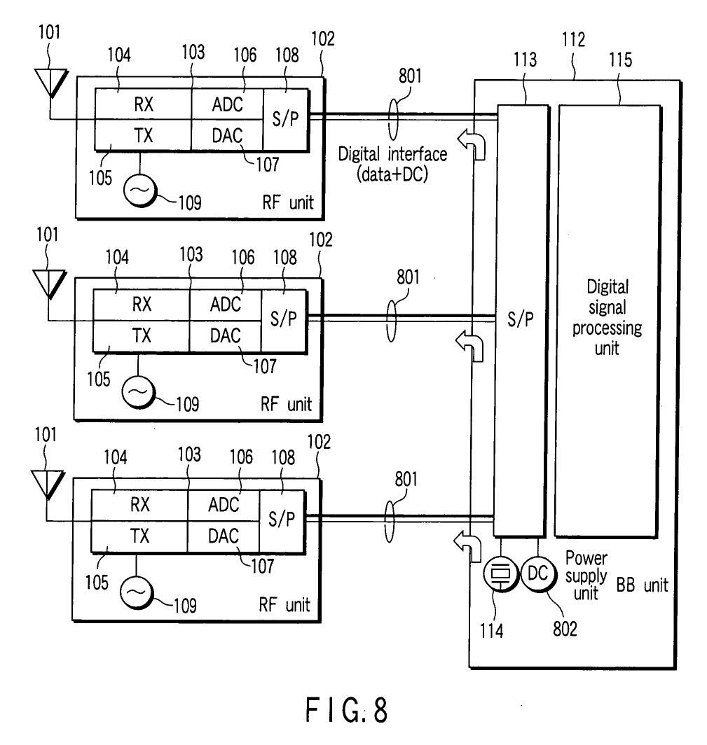

A radio apparatus according to the fourth embodiment of the present invention will be described with reference to FIG. 8. FIG. 8 is a block diagram when power is supplied from a baseband processing unit. The radio apparatus in the fourth embodiment has a digital interface 801 which includes a DC (power supply) line for an RF unit 102 in addition to a digital interface 111 in the first embodiment to distribute a signal. The digital interface 801 via which each RF unit 102 and a baseband processing unit 112 are connected is one connection line similar to the digital interface 111, physically. In the fourth embodiment, a TCXO 114 also supplies, to each RF unit 102, a common signal shared by all synthesizers 109.

The radio apparatus in the fourth embodiment has a power supply 802 in the baseband processing unit 112 which supplies power to each radio unit via the digital interface 801. In this arrangement, another power supply line need not be arranged in addition to a signal line to the radio unit 103, thus reducing the number of lines as a great merit, similar to the third embodiment. More specifically, the baseband processing unit 112 and the RF unit 102 are simply connected to each other when these units are arranged at physically separate locations. Hence, this is very advantageous in terms of space and cost.

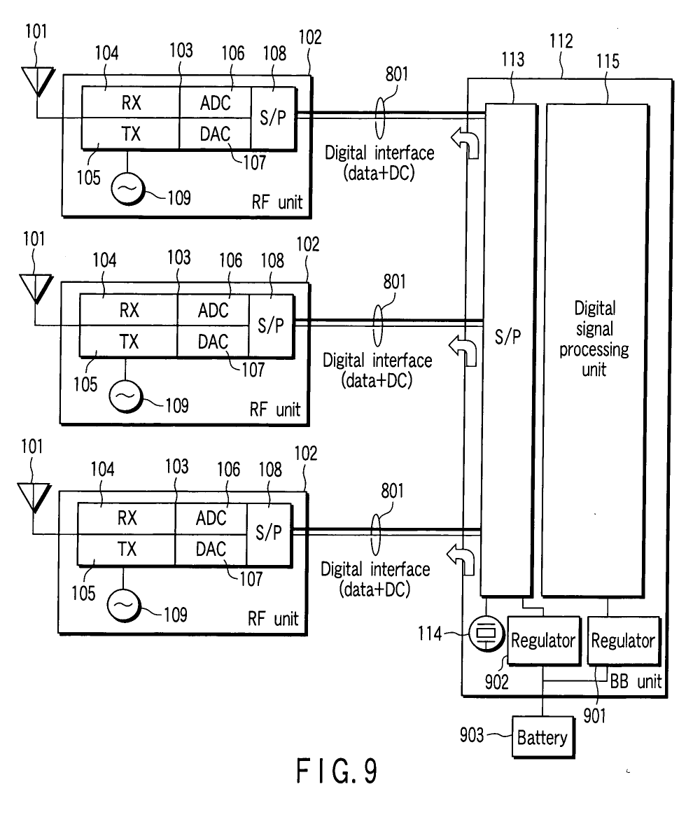

A detailed DC feeding scheme will be described next with reference to FIG. 9.

A regulator 901 for the digital signal processing unit and a regulator 902 for the RF units are prepared in the baseband processing unit 112. Each of these regulators is connected to an external power supply, e.g., a battery 903 to apply a constant voltage to each unit. The regulator 901 for the digital signal processing unit supplies power to the digital circuit of the baseband processing unit. On the other hand, the regulator 901 for the RF units generates a voltage to be supplied to the RF units 102. The regulator 902 for the RF units supplies a power supply voltage to the RF units 102 via the respective digital interfaces 801.

With this operation, the voltage need not be directly and individually supplied from the battery to each RF unit 102, thus largely reducing the space occupied by the lines. Also, the sources of the lines to the RF unit 102 can be centralized at the baseband processing unit 112, and the lines need not be complicated. Note that the DC power may be supplied to each RF unit 102 via the line which is dedicated to power supply, and physically different from the signal line. Alternatively, the DC power may be supplied by superimposing on the digital interface 801.

### Fifth Embodiment

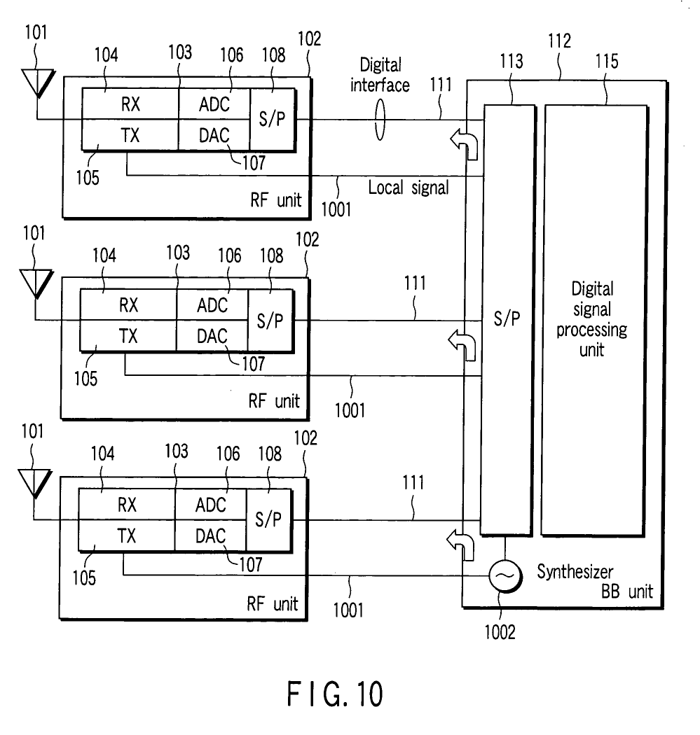

A radio apparatus according to the fifth embodiment of the present invention will be described with reference to FIG. 10. FIG. 10 is a block diagram when a synthesizer is included in a baseband processing unit to supply a local signal to each radio unit.

In the radio apparatus according to the fifth embodiment, a synthesizer 1002 is included in a baseband processing unit 112, and a signal from the synthesizer 1002 is distributed to radio units 103 via respective signal lines 1001. The synthesizer 1002 includes a synthesizer 109, PLL circuit 110, and TCXO 114 shown in FIG. 1. In the first embodiment of the present invention, a reference signal from the TCXO is distributed to the radio units 103. However, the fifth embodiment is different from the first embodiment in that the signal is supplied from the synthesizer to each radio unit.

In the above-described first embodiment, the TCXO is included in the baseband processing unit 112, and the signal from the TCXO is transmitted to each RF unit 102. The transmitted signal is used as the reference signal of the synthesizers 109 in the RF units 102 to fully match the frequencies of the synthesizers.

However, in the first embodiment, since the RF units 102 have the respective synthesizers 109, the transient responses of the synthesizers 109 may be different from each other in the respective radio units. Generally, the synthesizer is very weak against disturbance, and an oscillation frequency sometimes transiently varies depending on a sneak transmission signal. In such case, although the oscillation frequencies can match each other in a steady state, for example, transmission and reception characteristics are sometimes degraded in MIMO, when the frequencies of the respective radio units slightly vary at, e.g., the heads of packets.

When the synthesizer 1002 is included in the baseband processing unit 112 as in the fifth embodiment, even when the oscillation frequency of the synthesizer 1002 transiently varies depending on, e.g., the disturbance, the frequency distributed to the respective radio units 103 transiently varies at the same degree. Hence, the transmission and reception characteristics are not degraded even when the synthesizer is used in, e.g., MIMO, as a great merit.

Note that the embodiments of the present invention are not limited to such precise embodiments, and various modifications may be effected without departing from the spirit or scope of the embodiments of the invention. For example, a MIMO radio apparatus is used in the above embodiments. However, the embodiments of the present invention can be applied to a diversity receiver.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A radio apparatus comprising:
a first radio-frequency unit configured to receive a reception signal transmitted from a communication partner, and configured to transmit a transmission signal to the communication partner;
a second radio-frequency unit configured to receive a reception signal transmitted from the communication partner, configured to transmit a transmission signal to the communication partner;
a baseband processing unit configured to be supplied with the reception signal from each of the first radio-frequency unit and the second radio-frequency unit, and supply, to each of the first radio-frequency unit and the second radio-frequency unit, data to be transmitted to the communication partner, and the baseband processing unit configured to generate a reference signal supplied to each of the first radio-frequency unit and the second radio-frequency unit; and
a digital signal supplying unit configured to supply a digital signal containing the reference signal from the baseband processing unit to each of the first radio-frequency unit and the second radio-frequency unit.

2. The apparatus according to claim 1, wherein each of the first radio-frequency unit and the second radio-frequency unit is configured to receive, via an antenna, a plurality of different signals transmitted from the communication partner at a same frequency.

3. The apparatus according to claim 1, wherein the digital signal supplying unit is configured to serve as a plurality of signal lines, one of which supplies the reference signal.

4. The apparatus according to claim 1, further comprising an extractor configured to extract the reference signal from the digital signal.

5. A radio apparatus comprising:
a first radio-frequency unit configured to receive a reception signal transmitted from a communication partner, and configured to transmit a transmission signal to the communication partner;
a second radio-frequency unit configured to receive a reception signal transmitted from the a communication partner, configured to transmit a transmission signal to the communication partner;
a baseband processing unit configured to be supplied with the reception signal, and supply, to each of the first radio-frequency unit and the second radio-frequency unit, data to be transmitted to the communication partner, and the baseband processing unit configured to generate at least one of a switching control signal for switching a transmission operation and a reception operation in each of the first radio-frequency unit and the second radio-frequency unit, a power consumption control signal for changing power consumed by each of the first radio-frequency unit and the second radio-frequency unit, a transmission power control signal for changing transmission power in each of the first radio-frequency unit and the second radio-frequency unit, and a setting control signal for setting an oscillation frequency of each of the first radio-frequency unit and the second radio-frequency unit; and
a digital signal supplying unit configured to transmit a digital signal containing the control signal from the baseband processing unit to each of the first radio-frequency unit and the second radio-frequency unit.

6. The apparatus according to claim 5, wherein each of the first radio-frequency unit and the second radio-frequency unit further comprises a synthesizer, the baseband processing unit is configured to generate a reference signal supplied to each of the first radio-frequency unit and the second radio-frequency unit, the reference signal being referred in synthesizers including the synthesizer, and the digital signal supplying unit is configured to transmit a digital signal containing the reference signal from each of the first radio-frequency unit and the second radio-frequency unit to the baseband processing unit.

7. The apparatus according to claim 6, wherein
each of the first radio-frequency unit and the second radio-frequency unit is configured to generate a received signal strength signal indicating a strength of the reception signal, and
the baseband processing unit performs a decoding process, based on the received signal strength signal transmitted via the digital signal supplying unit, the received signal strength signal being included in the digital signal.

8. The apparatus according to claim 7, wherein the digital signal supplying unit is configured to supply at least one of the switching control signal, the power consumption control signal, the transmission power control signal, the setting control signal; and the received signal strength signal, during a period except a first period between a period for transmitting the data to the communication partner from the baseband processing unit to each of the first radio-frequency unit and the second radio-frequency unit, and a second period for transmitting the signal supplied from each of the first radio-frequency unit and the second radio-frequency unit to the baseband processing unit.

9. The apparatus according to claim 8, wherein the digital signal supplying unit is configured to serve as a plurality of signal lines, one of which transmits at least one of the switching control signal, the power consumption control signal, the transmission power control signal, the setting control signal, and the received signal strength signal, and another of which transmits the data to the communication partner and the signal supplied from each of the first radio-frequency unit and the second radio-frequency unit.

10. A radio apparatus comprising:
a first radio-frequency unit configured to receive a reception signal transmitted from a communication partner;
a second radio-frequency unit configured to receive a reception signal transmitted from the communication partner;
a baseband processing unit configured to be supplied with the reception signal, and supply, to each of the first radio-frequency unit and the second radio-frequency unit, data to be transmitted to the communication partner, and configured to supply power to the baseband processing unit and each of the first radio-frequency unit and the second radio-frequency unit; and
a transmitting unit configured to transmit, from the baseband processing unit to each of the first radio-frequency unit and the second radio-frequency unit, power to be supplied to each of the first radio-frequency unit and the second radio-frequency unit.

11. A radio apparatus comprising:
a first radio-frequency unit configured to receive a reception signal transmitted from a communication partner;
a second radio-frequency unit configured to receive a reception signal transmitted from the communication partner;
a baseband processing unit configured to be supplied with the reception signal, and supply, to each of the first radio-frequency unit and the second radio-frequency unit, data to be transmitted to the communication partner, and configured to supply, to each of the first radio-frequency unit and the second radio-frequency unit, a power supply voltage output from an external battery; and
a supplying unit configured to supply the power supply voltage from the baseband processing unit to each of the first radio-frequency unit and the second radio-frequency unit.

12. A radio apparatus comprising:
a first radio-frequency unit configured to receive a reception signal transmitted from a communication partner, and a transmission signal transmitter which transmits a transmission signal to the communication partner;
a second radio-frequency unit configured to receive a reception signal transmitted from the communication partner, and a transmission signal transmitter which transmits a transmission signal to the communication partner;
a baseband processing unit configured to be supplied with the reception signal, and supply, to each of the first radio-frequency unit and the second radio-frequency unit, data to be transmitted to the communication partner, and configured to generate an oscillation frequency signal for setting a transmission frequency or a reception frequency in each of the first radio-frequency unit and the second radio-frequency unit; and
a supplying unit configured to supply the oscillation frequency signal from the baseband processing unit to each of the first radio-frequency unit and the second radio-frequency unit.
